(19) United States
(12) Patent Application Publication
(10) Pub. No.: US 2024/0242062 A1
(43) Pub. Date: Jul. 18, 2024

(54) GOVERNING PROCESSING STEPS FOR EFFECTIVE MANAGEMENT OF ANALYTIC PIPELINES TO WHICH THEY CONTRIBUTE

(71) Applicant: CLOUD SOFTWARE GROUP, INC., Ft. Lauderdale, FL (US)

(72) Inventors: Thomas HILL, Tulsa, OK (US); Lawrence DERANY, Wellesley, MA (US); Eduardo GALVEZ, Belmont, MA (US); Sai Venu Gopal LOLLA, Tulsa, OK (US); Daniel John SIFTER, San Francisco, CA (US); Mark PALMER, New York, NY (US)

(73) Assignee: CLOUD SOFTWARE GROUP, INC., Ft. Lauderdale, FL (US)

(21) Appl. No.: 18/096,436

(22) Filed: Jan. 12, 2023

(51) Int. Cl. G06N 3/042; G06F 18/20; G06F 18/214

(52) U.S. Cl. CPC G06N 3/042; G06F 18/214; G06F 18/29

(57) ABSTRACT

Systems and methods to implement a model operation application are provided. The method includes defining a plurality of artifacts of a model operation application, where each artifact has an abstract interface, and each artifact is invoked by a corresponding reference. The method also includes organizing references of data inputs and data sinks of the model operation application into a data channel, where the data channel includes one or more data channel artifacts of the plurality of artifacts. The method further includes combining a plurality of processing steps by reference into a scoring flow, wherein the scoring flow is configured to be managed as one or more scoring flow artifacts of the plurality of artifacts. The method further includes attaching the data channel to the scoring flow to form a scoring pipeline, wherein the scoring pipeline comprises one or more scoring pipeline artifacts of the plurality of artifacts.

### BACKGROUND

The present disclosure relates generally to systems and methods to implement a model operation application.

Model operation applications are applications that facilitate management of analytic models including artificial intelligence, machine learning, and other computational processing that derive predictions, prediction models, and/or one or more results associated with statistics or other numeric summaries of predictions from data. Many model operation applications are deployed as single artifacts. More particularly, some model operation applications utilize a single artifact to manage each of hundreds or thousands or more pipelines. This approach is inefficient, and lacks transparency.

### BRIEF DESCRIPTION OF THE DRAWINGS

Illustrative embodiments of the present invention are described in detail below with reference to the attached drawing figures, which are incorporated by reference herein, and wherein:

FIG. 1 is a network environment for implementing a model operation application;

FIG. 2 is an illustration of a knowledge network graph having one scoring flow;

FIG. 3 is an illustration of a knowledge network graph having three scoring flows;

FIG. 4 is a system diagram of the model operation implementation system of FIG. 1; and

FIG. 5 is a flowchart of a process to implement a model operation application.

The illustrated figures are only exemplary and are not intended to assert or imply any limitation with regard to the environment, architecture, design, or process in which different embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

The present disclosure relates to systems and methods to implement a model operation application. A model operation implementation system manages data processing steps that are applied to data in a specific order, thereby transforming input data to resulting output data (“Results”) that inform downstream processes, applications, or people. A specific combination of processing steps that perform the computations to transform input data to Results are called scoring flow hereafter. In some embodiments, scoring flows define the data processing steps to transform input data to predictions regarding future and heretofore unobserved events based on statistical, artificial-intelligence-based, or machine-learning based prediction models. In some embodiments, scoring flows define the data processing steps to transform input data to one or more Results tables that summarize clusters of observations, dimensions with respect to input variables, important input variables with respect to some specific user-defined criteria, or identify atypical observations (“Outliers”), or report aggregations and various summary statistics for the respective input data.

When a scoring flow is connected to specific input data and downstream output data (data tables; hereafter referred to as “data sinks”), applications, or automated processes, the specific application of that scoring flow to specific data inputs and sinks is called scoring pipeline hereafter. In some embodiments, specific data processing steps are used in one or more scoring flows. In one or more of such embodiments, specific scoring flows and the processing steps they contain, input data, or data sinks are used in one or more scoring pipelines.

Moreover, the model operation application manages input data and data sinks, scoring flows and scoring pipelines, and the data processing steps that make up the scoring flows and scoring pipelines as reusable artifacts by reference. The management of those artifacts in the model operation application permits versioning, access, audit, and edit permissions, approvals, and other properties that can be assigned to those artifacts. For example, a specific version of an artifact is or is not approved for use in specific applications or use cases, or a scoring flow is approved for use with specific input data or data sinks that inform actual decisions and processes affecting customers, clients, patients, product quality, or other outcomes that affect key performance indicators established by a user organization for measuring organizational performance.

In some embodiments, the use of artifacts in scoring flows and scoring pipelines by reference means that multiple scoring flows or scoring pipelines use the identical data and/or processing steps, so that any approved changes to the respective data or processing steps will automatically affect scoring flows and scoring pipelines that use them. In some embodiments, the model operation system provides an option to users to select the specific scoring flows and/or scoring pipelines that are to be updated by referencing the changed respective input data, data sinks, or processing steps, while other scoring flows and/or scoring pipelines are to continue using the previously referenced unchanged version of the respective data or processing steps. In that regard, the model operation implementation systems and application described herein not only manage scoring flows and scoring pipelines, but also process steps or input and output data that make up the scoring flows or scoring pipelines.

In some embodiments, the model operation implementation is compatible with processing steps encoded in different formats (such as Python or R scripts/notebooks), complete other/external pipelines, or using any other method or format by which data inputs, data outputs, and data processing steps are encoded and parameterized. In that regard, the disclosed model operation implementation system is configurable to combine individual processing steps and data connections into scoring flows and scoring pipelines by reference, so that the relationships between processing steps, data, labels and metadata, and the scoring flows and scoring pipelines where they are used or to which they apply are managed as a knowledge network graph.

The model operation implementation system creates or defines artifacts of a model operation application, where each artifact has an abstract interface, and where each artifact is invoked by a corresponding reference (such as by reference to an actual instantiation of said artifact). The model operation implementation system organizes references of data inputs and references of data sinks of the model operation application into a data channel, where the data channels represent one or more artifacts managed by the model operation implementation systems. As referred to herein, a data channel is a physical data repository and definition of data and data fields that it contains. More particularly, a data channel is a reference to actual data or data inputs and/or data sinks. For example, a data channel “Customers in the Northeast” defines a database table, hosted at some database server, along with the specific query used to extract specific data from that table, such as, for example “the top 10 customers, by Gender.” In some embodiments, a data channel defines a data table and sink of “Customers in the Northeast, and their predicted propensity—expressed as a prediction probability computed by a scoring flow—to purchase a car in the next month.” Data channels are themselves artifacts that are managed, secured, approved, version-controlled with audit logs, and so on, as are all artifacts, including and all processing steps, scoring flows, and scoring pipelines in the system. In one or more of such embodiments, data channels, data processing steps, scoring flows, and scoring pipelines are managed as artifacts in the disclosed system, and as such, for example data inputs and data sinks represent immutable (versioned, approved, secured) records of both the input data as well as the data outputs and specific analytic predictions, summaries, or other results emitted by attached scoring flows. In some embodiments, artifacts such as data channels are managed independently by different groups of users than those users who manage the data processing steps, for example, the processing steps that define the artificial-intelligence-based or machine learning-based logic that utilizes the data channels.

In some embodiments, the scoring flows only define the data input schema that defines the “shape” of the input data used by the first processing step of the respective scoring flow, as well as the shapes of the output data sinks that are emitted by one or more processing steps in the respective scoring flow. By abstracting away the details of the input data and data sinks, the logic of the scoring flow is detached and independent of the data used to evaluate it, or emitted by it downstream. This allows the model operation implementation system to independently evaluate, approve, or otherwise govern both the data processing logic expressed by the processing steps in the flow, and the data inputs and sinks for appropriateness, correctness, and compliance with data (e.g., privacy) protection and other applicable regulations.

The model operation implementation system attaches the data channel to the scoring flow to form a scoring pipeline, where the scoring pipeline includes one or more scoring pipeline artifacts of the plurality of artifacts. More particularly, when data channels are attached to scoring flows, the resulting artifact is a scoring pipeline. In some embodiments, scoring pipelines are concrete instances of applications of specific scoring flows to specific data channels, i.e., data inputs and data sinks. By combining managed scoring flows with managed data channels, detailed forensic trails and records are maintained for data auditability, compliance, as well as after-the-fact forensic analyses of decisions made or informed by scoring pipelines.

In some embodiments, the model operation implementation system labels one or more artifacts of the model operation application with metadata. For example, artifacts are labeled as “approved-for-production,” thereby entitling and permitting such artifacts to be used in production deployments, affecting actual business processes and decisions. In some embodiments, artifacts are also labeled with information identifying the teams or individual team members who created or last modified an artifact, or who labeled an artifact as “approved-for-production.” In some embodiments, metadata are attached to specific processing steps used in a scoring flow or pipeline labeled “always-use-last-approved-version,” so that when a newer version of said artifact is available, that artifact will automatically be referenced the next time that scoring flow or pipeline is accessed or used.

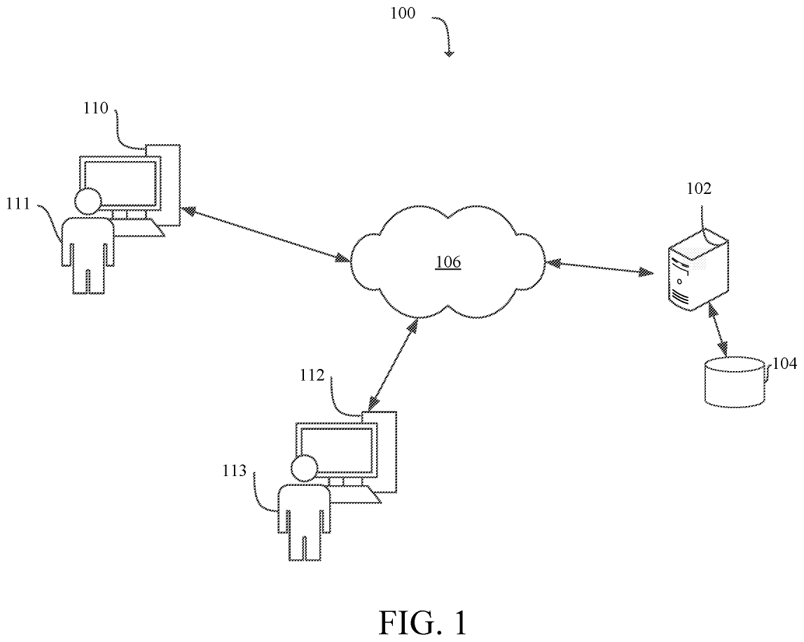

In some embodiments, the model operation implementation system forms a knowledge network graph from the data channel, the data processing steps, the scoring flow, and the scoring pipeline, where one or more nodes and connectors of the knowledge network graph represent the data channel, data processing steps, the scoring flow, or the scoring pipeline. In some embodiments, the model operation implementation system also provides the knowledge network graph for display on a display screen of a user. In some embodiments, one or more components of the knowledge network graph is editable by the user. In some embodiments, the model operation implementation system, in response to receiving an instruction to modify the knowledge network graph (e.g., the data channel, the scoring flow, or the scoring pipeline, or another component of the knowledge network graph), identifies a corresponding artifact associated with a component of the knowledge network graph that the user seeks to modify (e.g., the data channel, the scoring flow, or the scoring pipeline), and modifies the corresponding artifact. In one or more of such embodiments, the model operation implementation system modifies the corresponding artifact without modifying any unrelated artifacts. In one or more of such embodiments, the model operation implementation system dynamically propagates the modification throughout the knowledge network graph (e.g., the data channel, the scoring flow, and the scoring pipeline) to update the knowledge network graph accordingly. Additional descriptions of the model operation implementation system and operations performed by the model operation implementation system are provided in the paragraphs below and are illustrated in at least FIGS. 1-5.

FIG. 1 is a network environment 100 for implementing a model operation application in accordance with one embodiment. Network environment 100 includes a model operation implementation system 102 that is communicatively connected to an electronic device 110 that is operated by a user 111 (e.g., a data scientist), and a second electronic device 112 that is operated by a second user 113 via a network 106.

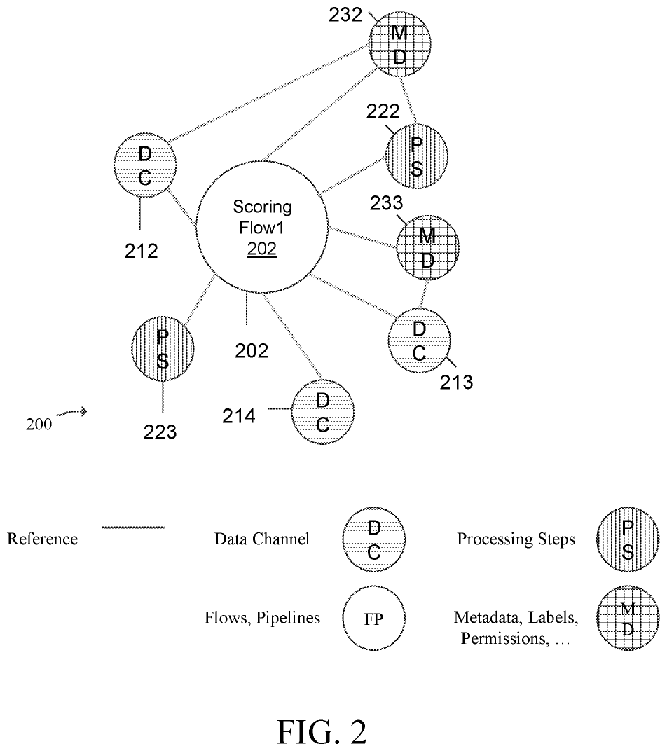

Model operation implementation system 102 may be formed from one or more work management stations, server systems, private, public, on-prem, or federated cloud-based systems, parallel-computing systems, multi-network computing systems, ad hoc network computing systems, desktop computers, laptop computers, tablet computers, smartphones, smart watches, virtual reality systems, augmented reality systems, as well as similar electronic devices having one or more processors operable to define artifacts of a model operation application, organize references of one or more data inputs and data sinks of the model operation application into one or more data channels, combine a plurality of processing steps by reference into a scoring flow, and attach the data channel to the scoring flow to form a scoring pipeline. Additional descriptions of operations performed by model operation implementation system 102 are provided herein and are illustrated in at least FIGS. 2-5. Model operation implementation system 102 includes or is communicatively connected to a storage medium, such as storage medium 104. Storage medium 104 stores instructions, which, when executed by one or more processors of model operation implementation system 102, cause the processors to perform the foregoing operations as well as other operations described herein. Storage medium 104, in addition to storing executable instructions, also stores metadata associated with the artifacts. Storage medium 104 also stores information provided by electronic devices 110 and 112, and by other model operation application storage systems (not shown) and other electronic devices (not shown). Storage medium 104 may be formed from data storage components such as, but not limited to, read-only memory (ROM), random access memory (RAM), flash memory, magnetic hard drives, solid state hard drives, CD-ROM drives, DVD drives, floppy disk drives, as well as other types of data storage components and devices. In some embodiments, storage medium 104 includes multiple data storage devices. In further embodiments, the multiple data storage devices may be physically stored at different locations. In one of such embodiments, the data storage devices are components of a server station, such as a cloud server. In another one of such embodiments, the data storage devices are components of model operation implementation system 102.

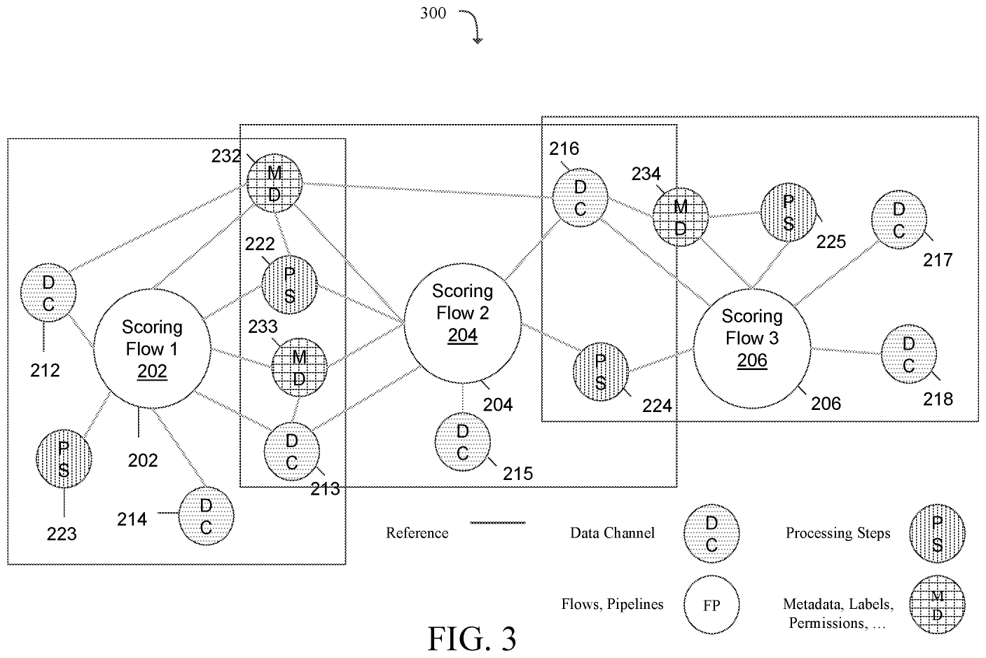

In the embodiment of FIG. 1, model operation implementation system 102 forms a knowledge network graph from data channels, scoring flows, scoring pipelines, and other components of a model operation application, and provides the knowledge network graph for display on electronic devices 110 and 112. Example illustrations of a knowledge network graph are provided in FIGS. 2 and 3 and are described herein. Each of electronic device 110 and electronic device 112 includes any devices that are operable to provide a knowledge network graph for display, and provide one or more user implemented modifications to components of the knowledge network graph to model operation implementation system 102. In the embodiment of FIG. 1, electronic devices 110 and 112 are desktop computers. Additional examples of electronic devices include, but are not limited to, laptop computers, tablet computers, smartphones, smart watches, virtual reality systems, augmented reality systems, as well as similar electronic devices having a processor operable to provide a knowledge network graph for display.

Users 111 and 113 work together on modifying an identical component, or work separately to concurrently or sequentially update different components of the knowledge network graph. For example, where the knowledge network graph includes multiple scoring flows (such as shown in FIG. 3), the knowledge network graph permits users 111 and 113 to work on modifying different scoring flows (e.g., different data channels of different scoring flows) to expedite the modification process without intruding on each other. In that regard, the separation of processing steps and scoring flows from data channels empowers users such as users 111 and 113, as well as other stakeholders, teams, and/or team members responsible for managing and validating data stores, to deliver vetted, validated, and compliant (with applicable regulatory requirements) data to scoring flows, resulting in end-to-end vetted and validated scoring pipelines. The disclosed implementation of model operation applications, knowledge network graphs, and corresponding architecture permits teams of data, business, business-logic, and data science/artificial intelligence experts to collaborate, perform targeted root cause analysis of malfunctions, and respond faster and in a more agile fashion to changing data and/or requirements. Therefore, the disclosed subject technology permits organizations to build, maintain, and manage complex systems of artificial intelligence and machine-learning infused processes, business intelligence dashboards, automated decision systems, and applications.

Network 106 can include, for example, any one or more of a cellular network, a satellite network, a personal area network (PAN), a local area network (LAN), a wide area network (WAN), a broadband network (BBN), an RFID network, a Bluetooth network, a device-to-device network, the Internet, and the like. Further, network 106 can include, but is not limited to, any one or more of the following network topologies, including a bus network, a star network, a ring network, a mesh network, a star-bus network, a tree or hierarchical network, or similar network architecture. Network 106 may be implemented using different protocols of the internet protocol suite such as TCP/IP. Network 106 includes one or more interfaces for data transfer. In some embodiments, network 106 includes a wired or wireless networking device (not shown) operable to facilitate one or more types of wired and wireless communication between model operation implementation system 102, electronic devices 110 and 112, as well as other electronic devices (not shown) and systems (not shown) communicatively connected to network 106. Examples of the networking device include, but are not limited to, wired and wireless routers, wired and wireless modems, access points, as well as other types of suitable networking devices described herein. Examples of wired and wireless communication include Ethernet, WiFi, Cellular, LTE, GPS, Bluetooth, and RFID, as well as other types of communication modes described herein.

Although FIG. 1 illustrates electronic devices 110 and 112 operated by users 111 and 113, respectively, in some embodiments, model operation implementation system 102 concurrently or periodically receives multiple requests to modify one or more components of the knowledge network graph or the model operation application from a different number of electronic devices (not shown) operated by a different number of users. Further, although model operation implementation system 102 is illustrated in FIG. 1 as a single system, in some embodiments, model operation implementation system 102 resides or operates on multiple electronic devices (not shown). In one or more of such embodiments, model operation implementation system 102 utilizes parallel computing, ad-hoc computing, or other types of multi-device computing operations from multiple electronic devices to simultaneously perform some of the operations described herein to balance the workload and to reduce the computation time associated with the operations. For example, model operation implementation system 102 is configured to utilize a first electronic device (not shown) to implement modifications made by user 111 and a second electronic device (not shown) to implement modifications made by user 113 to reduce the overall time to implement all of the modifications. Additional descriptions of the operations performed by model operation implementation system 102 and other model operation implementation systems described herein are provided in the paragraphs below.

FIG. 2 is an illustration of a knowledge network graph 200 having scoring pipeline 1 202. In the embodiment of FIG. 2, scoring flow 202 includes data channels 212-214, processing steps 222 and 223, and metadata 232 and 233. Data Channels 212-214, processing steps 222 and 223, processing flow 1 202, metadata (permissions, labels, etc.), pipelines, and the references among them are independent artifacts, and as such decoupled from each other, and managed and tracked independently from each other. Moreover, each artifact has an abstract interface and is invoked by a corresponding reference, so that the respective artifact remains loosely coupled but precisely defined and governed. The operation implementation system organizes references of data inputs and data sinks of the model operation application into data channels such as 212-214. The operation implementation system also combines processing steps, such as processing steps 222 and 223 by reference into one or more scoring flows. Further, the operation implementation system also attaches one or more data channels (e.g., 212-214) to the scoring flow to form one or more scoring pipelines.

FIG. 3 is an illustration of a knowledge network graph 300 having three scoring flows, including scoring flow 1 202 of FIG. 2, and scoring flow 2 and 3, 204 and 206, respectively, which are interconnected with each other via references, and share certain data channels, processing steps, and/or metadata. More particularly, scoring flow 1 202 includes data channels 212-214, processing steps 222 and 223, and metadata 232 and 233. Further, scoring flow 2 204 includes data channels 213, 215, and 216, processing steps 222, 223, and 224, and metadata 233 and 234. Further, scoring flow 3 206 includes data channels 216-218, processing steps 224 and 225, and metadata 234. In the embodiment of FIG. 3, scoring flows 1 (202) and 2 (204) share data channel 213, processing step 222, and metadata 232 and 233; and scoring flows 2 (204) and 3 (206) share data channel 216, processing step 224, and metadata 234, such that a modification of one of the foregoing nodes or components affects two different scoring flows.

The knowledge network graph is configured to form knowledge network graphs 200 and 300, and provide knowledge network graphs 200 and 300 for display, such as on the displays of electronic devices 110 and 112 of FIG. 1. In the embodiments of FIGS. 2 and 3, each of the data channels, processing steps, and metadata of knowledge network graphs 200 and 300 is modifiable, such as by users 111 and 113 of FIG. 1. For example, the model operation implementation system is configured to sequentially or simultaneously receive instructions from user 111 to modify a component of data channel 212 from user 111, and instructions from user 113 to modify a component of processing step 225. The knowledge network graph is further configured to implement the received requests to modify data channel 212 and processing step 225, and to cascade the modifications throughout knowledge network graph 300.

In some embodiments, the model operation implementation system is configured to allow automated updates to the underlying data channels (e.g., data channels 212-218) or processing steps (e.g., processing steps 222-225) without inducing disruptive and risky changes to existing scoring flows or pipelines. For example, if a scoring flow utilizes a processing step with a label “approved,” then the respective processing step will reference (be mapped to) to that specific version of the processing step; when changes to the processing step are made, a new version is automatically created (version control), but the respective scoring flow and pipelines will continue to use the unchanged and approved version of the respective processing steps. However, if a scoring flow uses processing steps with a label “latest,” then the respective processing step will reference the latest updated version of that processing step; when changes are introduced to that processing step, the flow would now use the latest updated version of the processing step. Thus, the model operation implementation system is configured to permit more control and agility to users with regard to the management of updates and changes, for example, which scoring flows and pipelines should or should not automatically receive updated processing steps or data channels. In that regard, the model operation implementation system permits a clear division of responsibilities between data engineers and experts, data scientists, statisticians, or other users to utilize, modify and update different components of the model operation application.

Although FIG. 3 illustrates a knowledge network graph 300 having three scoring flows 202, 204, and 206, in some embodiments, the model operation implementation system is configured to form knowledge network graphs (not shown) of model operation applications having many more scoring flows that are interconnected to each other, and share one or more data channels, processing steps, metadata, and other components. In that regard, the model operation implementation system is configured to perform the operations described herein to implement model operation applications that are easy to scale up to applications having hundreds, thousands, or more different scoring flows that are connected to each other by a web of references, data channels, processing steps, metadata, and other components, while permitting different users to sequentially or concurrently modify different components of the corresponding knowledge network graph.

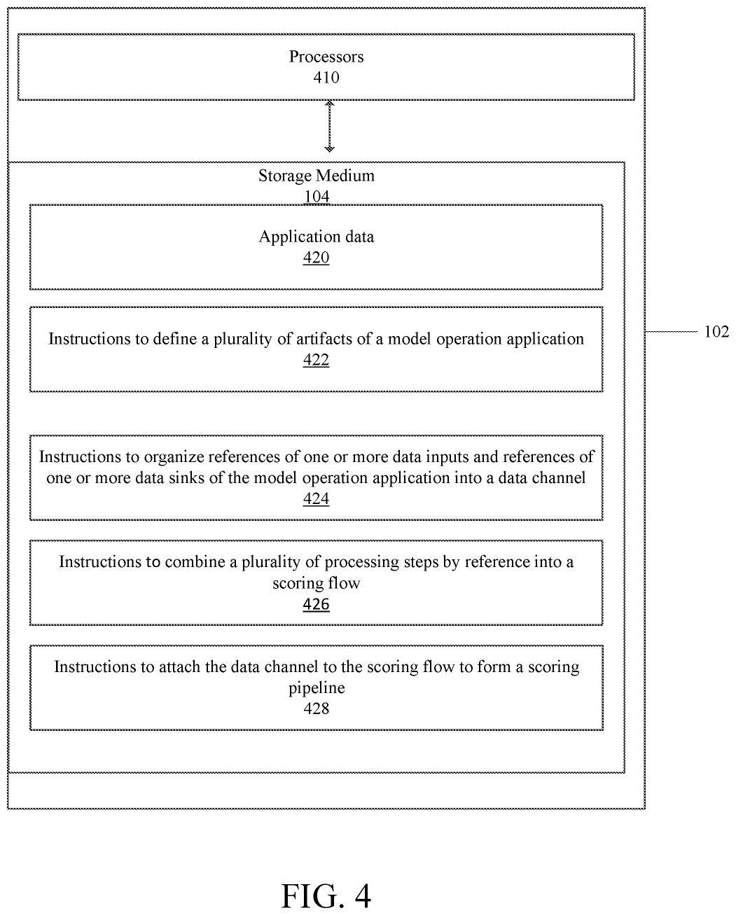

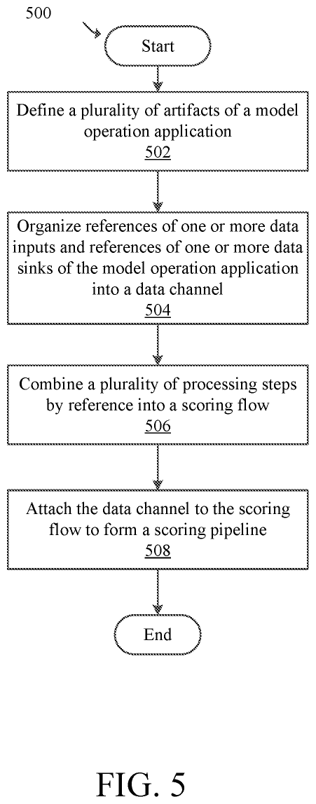

FIG. 4 is a system diagram of the model operation implementation system 102 of FIG. 1 in accordance with one embodiment. Model operation implementation system 102 includes or is communicatively connected to storage medium 104 and processors 410. Data associated with a model operation application (collectively “application data”) are stored at location 420 of storage medium 104. Instructions to define a plurality of artifacts of a model operation application are stored at location 422. Further, instructions to organize references of one or more data inputs and references of one or more data sinks of the model operation application into a data channel are stored at location 424. Further, instructions to combine a plurality of processing steps by reference into a scoring flow are stored at location 426. Further, instructions to attach the data channel to the scoring flow to form a scoring pipeline are stored at location 428. Further, instructions to perform operations described herein and shown in at least FIG. 5 are also stored in storage medium 104.

FIG. 5 is a flow chart illustrating a process 500 to implement a model operation application in accordance with one embodiment. Although the operations in process 500 are shown in a particular sequence, certain operations may be performed in different sequences or at the same time where feasible. Further, although process 500 is described to be performed by processors of model operation implementation system 102 of FIG. 1, it is understood that processors of other model operation implementation systems are also operable to perform process 500.

At block 502, a model operation implementation system, such as model operation implementation system 102 of FIG. 1 defines a plurality of artifacts of a model operation application, where each artifact has an abstract interface, and wherein each artifact is invoked by a corresponding reference. At block 504, the model operation implementation system organizes references of one or more data inputs and references of one or more data sinks of the model operation application into a data channel, where the data channel includes one or more data channel artifacts of the plurality of artifacts. In that regard, FIG. 3, for example, illustrates data channels 212-217 of scoring flows 1-3 202, 204, and 206, respectively. In some embodiments, the model operation implementation system manages and modifies a data channel via one or more artifacts (e.g., data channel artifacts) that are associated with the data channel.

At block 506, the model operation implementation system combines a plurality of processing steps by reference into a scoring flow, where the scoring flow is configured to be managed as one or more scoring flow artifacts. For example, the model operation implementation system is configured to combine processing steps 222 and 223 of scoring flow 1 202 of FIG. 3 into a scoring flow. In some embodiments, the scoring flow defines a shape of the one or more data inputs used by a processing step (e.g., processing step 222) that is associated with the scoring flow. In some embodiments, the scoring flow also defines a shape of the one or more data sinks that are emitted from a processing step (e.g., processing step 223) that is associated with the scoring flow. In some embodiments, the model operation implementation system manages the scoring flow via one or more scoring flow artifacts. At block 508, the model operation implementation system attaches the data channel to the scoring flow to form a scoring pipeline, where the scoring pipeline includes one or more scoring pipeline artifacts of the plurality of artifacts. In some embodiments, the model operation implementation system also labels one or more artifacts with corresponding metadata.

In some embodiments, the model operation implementation system organizes additional references of data inputs and data sinks into additional data channels of one or more scoring flows. In one or more of such embodiments, each scoring flow includes multiple data channels, each associated with references of a set of data inputs and a set of data sinks. In one or more of such embodiments, the model operation implementation system combines additional processing steps by reference into additional scoring flows. In one or more of such embodiments, the model operation implementation system also attaches one or more data channels to the additional scoring flows to form additional scoring pipelines. In one or more of such embodiments, the model operation implementation system forms a first scoring flow from a first set of data channels, scoring flows, and scoring pipelines, and forms a second scoring flow from a second set of data channels, scoring flows, and scoring pipelines that are interconnected with the first scoring flow via one or more references. In one or more of such embodiments, the first scoring flow and the second scoring flow share one or more data channels, and scoring pipelines.

In some embodiments, the model operation implementation system forms a knowledge network graph from the data channel, the scoring flow, and the scoring pipeline, where one or more nodes and connectors of the knowledge network graph represent the data channel, the scoring flow, or the scoring pipeline. FIG. 3, for example, illustrates a knowledge network graph 300 formed by the model operation implementation system. In some embodiments, the model operation implementation system also provides the knowledge network graph for display on a display on an electronic device, such as electronic device 110 and 112 of FIG. 1. In some embodiments, the knowledge network graph is partially or completely customizable and modifiable, thereby permitting one or more users to sequentially or concurrently modify and update one or more components of the model operation application as represented by the knowledge network graph. For example, the model operation implementation system concurrently permits user 111 of FIG. 1 to update data channel 212 of scoring flow 1 202 of FIG. 2, and permits user 113 of FIG. 1 to update processing steps 225 of soring flow 3 206 of FIG. 3. In one or more of such embodiments, the model operation implementation system receives instructions to modify a component data channel, the scoring flow, or the scoring pipeline, and in response to receiving the instruction to modify the data channel, the scoring flow, or the scoring pipeline, identifies a corresponding artifact associated with the data channel, the scoring flow, or the scoring pipeline, and modifies the corresponding artifact. In one or more of such embodiments, the model operation implementation system also dynamically propagates the modification throughout the data channel, the scoring flow, and the scoring pipeline. In one or more of such embodiments, the model operation implementation system also provides an updated knowledge network graph for display after each modification.

Although FIG. 5 illustrates a single sequence of operations at blocks 502, 504, 506, and 508, it is understood that the model operation implementation systems described herein are configured to perform multiple iterations of process 500, or one or more steps of process 500 to dynamically (and/or sometimes in response to receipt of user request) update some or all of the processing steps, storing flows, pipelines, data channels, metadata, labels, and other associated data. For example, model operation implementation system 102 of FIG. 1 is configured to dynamically (or upon receipt of a user request) perform another iteration of process 500 to “version up” to the most up-to-date version, and to dynamically update all of the associated data.

The implemented model operation application provides greater efficiency for users, such as data scientists, who are primarily responsible for building reusable processing steps and prediction models, as responsibility for deployment, approvals, governance, etc. is shared with or assumed by other roles/stakeholders. Further, the implemented model operation application decouples data from specific data pre-processing steps, predictive or artificial intelligence or machine learning model scoring steps, specific model-scoring post processing steps, and permits for teamwork and adjudication of data correctness, privacy, and compliance, i.e., to ensure that compliant data is used in “scoring” algorithms. Further, the implemented model operation application permits greater efficiency, agility, adaptability of the artificial intelligence system, and greater visibility and control, which, in turn, translates to faster changes and improvements with less effort and less hardware computation.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/processes may be performed in parallel or out of sequence, or combined into a single step/process.

As used herein, the singular forms “a,” “an,” and “the” are intended to include the plural forms as well, unless the context clearly indicates otherwise. It will be further understood that the terms “comprise” and/or “comprising,” when used in this specification and/or in the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

What is claimed is:

1. A computer-implemented method to implement a model operation application, the method comprising:
defining a plurality of artifacts of a model operation application, wherein each artifact has an abstract interface, and wherein each artifact is invoked by a corresponding reference;
organizing references of one or more data inputs and references of one or more data sinks of the model operation application into a data channel, wherein the data channel comprises one or more data channel artifacts of the plurality of artifacts;
combining a plurality of processing steps by reference into a scoring flow, wherein the scoring flow is configured to be managed as one or more scoring flow artifacts of the plurality of artifacts; and
attaching the data channel to the scoring flow to form a scoring pipeline, wherein the scoring pipeline comprises one or more scoring pipeline artifacts of the plurality of artifacts.

2. The computer-implemented method of claim 1, further comprising labeling an artifact of the plurality of artifacts with a metadata.

3. The computer-implemented method of claim 1, further comprising organizing references of a second set of one or more data inputs and references of a second set of one or more data sinks of the model operation application into a second data channel, wherein the second data channel comprises a second set of one or more data channel artifacts of the plurality of artifacts.

4. The computer-implemented method of claim 3, further comprising:
combining a second plurality of processing steps by reference into a second scoring flow, wherein the second scoring flow is configured to be managed as a second set of one or more scoring flow artifacts of the plurality of artifacts; and
attaching the second data channel to the second scoring flow to form a second scoring pipeline, wherein the second scoring pipeline comprises a second set of one or more scoring pipeline artifacts of the plurality of artifacts.

5. The computer-implemented method of claim 4, wherein the data channel, and the scoring flow form a first scoring pipeline, and wherein the second data channel and the second scoring flow form a second scoring pipeline that is interconnected with the first scoring pipeline.

6. The computer-implemented method of claim 1, further comprising forming a knowledge network graph from the data channel, the scoring flow, and the scoring pipeline, wherein one or more nodes and connectors of the knowledge network graph represent the data channel, the data processing steps, the scoring flow, or the scoring pipeline.

7. The computer-implemented method of claim 6, further comprising:
receiving an instruction to modify the data channel, the scoring flow, or the scoring pipeline;
in response to receiving the instruction to modify the data channel, the scoring flow, or the scoring pipeline:
identifying a corresponding artifact associated with the data channel, the scoring flow, or the scoring pipeline; and
modifying the corresponding artifact.

8. The computer-implemented method of claim 7, wherein modifying the corresponding artifact comprises modifying the corresponding artifact without modifying another artifact of the plurality of artifacts.

9. The computer-implemented method of claim 7, further comprising dynamically propagating a modification throughout the data channel, the scoring flow, and the scoring pipeline.

10. The computer-implemented method of claim 6, further comprising providing the knowledge network graph for display.

11. The computer-implemented method of claim 1, further comprising managing the data channel via the one or more data channel artifacts.

12. The computer-implemented method of claim 1, further comprising managing the scoring flow via the one or more scoring flow artifacts.

13. The computer-implemented method of claim 12, wherein the scoring flow defines a shape of the one or more data inputs used by a processing step that is associated with the scoring flow.

14. The computer-implemented method of claim 13, wherein the scoring flow defines a shape of the one or more data sinks that are emitted from a processing step that is associated with the scoring flow.

15. A model operation implementation system, comprising:
a storage medium; and
one or more processors configured to:
define a plurality of artifacts of a model operation application, wherein each artifact has an abstract interface, and wherein each artifact is invoked by a corresponding reference;
organize references of one or more data inputs and references of one or more data sinks of the model operation application into a data channel, wherein the data channel comprises one or more data channel artifacts of the plurality of artifacts;
combine a plurality of processing steps by reference into a scoring flow, wherein the scoring flow is configured to be managed as one or more scoring flow artifacts of the plurality of artifacts;
attach the data channel to the scoring flow to form a scoring pipeline, wherein the scoring pipeline comprises one or more scoring pipeline artifacts of the plurality of artifacts; and
label an artifact of the plurality of artifacts with a metadata.

16. The model operation implementation system of claim 15, wherein the one or more processors are further configured to:
organize references of a second set of one or more data inputs and references of a second set of one or more data sinks of the model operation application into a second data channel, wherein the second data channel comprises a second set of one or more data channel artifacts of the plurality of artifacts;
combine a second plurality of processing steps by reference into a second scoring flow, wherein the second scoring flow is configured to be managed as a second set of one or more scoring flow artifacts of the plurality of artifacts; and
attach the second data channel to the second scoring flow to form a second scoring pipeline, wherein the second scoring pipeline comprises a second set of one or more scoring pipeline artifacts of the plurality of artifacts,
wherein the data channel, and the scoring flow, form a first scoring pipeline, and wherein the second data channel and the second scoring flow form a second scoring pipeline that is interconnected with the first scoring pipeline.

17. The model operation implementation system of claim 16, wherein the one or more processors are further configured to form a knowledge network graph from the data channel, the scoring flow, and the scoring pipeline, wherein one or more nodes and connectors of the knowledge network graph represent the data channel, the scoring flow, or the scoring pipeline.

18. The model operation implementation system of claim 17, wherein the one or more processors are further configured to:
receive an instruction to modify the data channel, the scoring flow, or the scoring pipeline;
in response to receiving the instruction to modify the data channel, the scoring flow, or the scoring pipeline:
identify a corresponding artifact associated with the data channel, the scoring flow, or the scoring pipeline; and
modify the corresponding artifact,
wherein modifying the corresponding artifact comprises modifying the corresponding artifact without modifying another artifact of the plurality of artifacts.

19. A non-transitory machine-readable medium comprising instructions, which, when executed by a processor, causes the processor to perform operations comprising:
defining a plurality of artifacts of a model operation application, wherein each artifact has an abstract interface, and wherein each artifact is invoked by a corresponding reference;
organizing references of one or more data inputs and references of one or more data sinks of the model operation application into a data channel, wherein the data channel comprises one or more data channel artifacts of the plurality of artifacts;
combining a plurality of processing steps by reference into a scoring flow, wherein the scoring flow is configured to be managed as one or more scoring flow artifacts of the plurality of artifacts;
attaching the data channel to the scoring flow to form a scoring pipeline, wherein the scoring pipeline comprises one or more scoring pipeline artifacts of the plurality of artifacts; and
labeling an artifact of the plurality of artifacts with a metadata.

20. The non-transitory machine-readable medium of claim 19, further comprising instructions, which, when executed by the processor, cause the processor to perform operations comprising:
forming a knowledge network graph from the data channel, the scoring flow, and the scoring pipeline, wherein one or more nodes and connectors of the knowledge network graph represent the data channel, the scoring flow, or the scoring pipeline;
receiving an instruction to modify the data channel, the scoring flow, or the scoring pipeline;
in response to receiving the instruction to modify the data channel, the scoring flow, or the scoring pipeline:
identifying a corresponding artifact associated with the data channel, the scoring flow, or the scoring pipeline; and
modifying the corresponding artifact,
wherein modifying the corresponding artifact comprises modifying the corresponding artifact without modifying another artifact of the plurality of artifacts.
